(19) United States
(12) Patent Application Publication
(10) Pub. No.: US 2026/0026528 A1
(43) Pub. Date: Jan. 29, 2026

(54) MAXIMIZING UTILIZATION OF AMINO ACIDS AND ENZYMES

(71) Applicants: Steven A. Shoup, New Plymouth, ID (US); Barry G. Roberts, Atlanta, GA (US)

(72) Inventors: Steven A. Shoup, New Plymouth, ID (US); Barry G. Roberts, Atlanta, GA (US)

(21) Appl. No.: 18/786,778

(22) Filed: Jul. 29, 2024

Related U.S. Application Data
(60) Provisional application No. 63/654,174, filed on May 31, 2024.

(51) Int. Cl. A23K 40/20

(52) U.S. Cl. CPC A23K 40/20

(57) ABSTRACT

Compositions and methods are provided for improving feed conversion through retention and utilization of amino acids and enzymes in feedstock and reducing operating costs during a feed pellet creation process.

### CROSS REFERENCE TO RELATED APPLICATION

This application claims priority to U.S. Provisional Application No. 63/654,174 filed May 31, 2024, which is incorporated herein by reference in its entirety.

### BACKGROUND OF THE INVENTION

Enhancing the utilization of proteins in the processing of foods yields myriad benefits across both animal and human nutrition realms. Improving the utilization of both free and added amino acids and enzymes presents a spectrum of advantages in various industries, particularly in agriculture and food processing. Amino acids play a pivotal role in enhancing nutrient absorption, bolstering health, and inhibiting pathogenic microorganisms in livestock that result in improved feed efficiency and reduced reliance on antibiotics. Meanwhile, the enzymes facilitate the breakdown of complex molecules, such as starches and proteins, augmenting nutrient accessibility in most animals. Any approach that optimizes feed conversion rates and nutrient utilization fosters environmental sustainability by reducing waste and minimizing the environmental impact of agricultural operations.

Products, such as breakfast cereals, dog food, livestock feed, snack bars, and human supplement powders, all can benefit by the better utilization of amino acids and enzymes in the processing of these foods. By optimizing the amino acid profile, these products can offer superior protein quality that promotes better muscle development, immune function, and overall health in livestock, pets, and humans alike. For example, in human supplements, such enhancements can lead to better muscle recovery, increased athletic performance, and support for various metabolic functions. Thus, applying methods that elevate the nutritional value of these products creates significantly healthier outcomes for the consumers.

Specifically, implementing processes that enhance feed conversion, improve feed stability and quality, while diminishing forming fines are highly beneficial across the agricultural and feed production sectors. Optimizing feed conversion rates directly translates to more efficient resource utilization and drastically reducing feed costs. Higher quality feed forms, such as pellets, maximize nutrient delivery to animals and promote better health and growth of livestock. Poultry and other animals gain weight quicker and better with increased amino acids. Additionally, a reduction in pellet fines minimizes feed waste and enhances handling efficiency. Accordingly, creating better pelleted animal feeds can greatly increase the world's food supply and significantly reduce costs associated with raising poultry and other animals.

Furthermore, increasing the amounts of amino acids and enzymes also has the benefit of extending the usable shelf life of packaged feed. Feed pellets may last only one to six months in poor storage conditions. However, starting with more lysine and other amino acids, the shelf life can be extended because the feed pellets start with higher levels of the amino acids.

There are many ways to destroy a protein that include exposure to high temperatures, mechanical shear, over pressure and, of course, chemical processes. In feed processing plants today, the steam boilers typically run near maximum boiler efficiency around 344 degrees Fahrenheit (° F.). This condition is achieved with the steam valve 10% to 20% open. Consequently, the conditioning is usually performed with around 100-110 pounds per square inch (psi) steam, which corresponds to approximately 340-350 degrees Fahrenheit. Temperatures over 268° F. rapidly destroy bacteria and harmful microbes. Although high temperatures are effective in killing bacteria, temperatures over 268° F. starts destroying lysine, while thymine begins to be destroyed at 300° F. Therefore, using lower temperatures will reduce the destruction of intrinsic enzymes and amino acids.

All boilers create saturated stable steam. “Saturated steam” will be defined as the steam with the dryness created by a boiler (Steam Dryness=100%−[% Entrained Water]) or any higher percentage of dry steam.

If boiler temperature is reduced while maintaining consistent regulator pressure it is possible to produce evaporative and condensate stage steam much faster. In modern boilers, regulator pressure and boiler temperature are linear. As steam reduces temperature, it passes through the evaporative stage and into the condensate stage. The goal of the process outlined herein is to eliminate out of equilibrium steam and to move the process steam through the evaporative stage and into the condensate stage much faster than conventional methods.

By using lower temperature steam and increasing the retention time in feed conditioners, the amount of moisture in the outer layer of a grain particle greatly increases because the particle will absorb some moisture from the wet steam vapor. This moisture will act as a lubricant during further processing that allows for the reduction of mechanical shear forces in the later processing steps. Conversely, very high temperature with lower moisture containing steam will draw moisture out of the feed particles and minimize the lubrication effect that can result in difficulty holding pellets together and creating more fines while also allowing mechanical destruction of proteins.

The goal of the present invention is to create wet steam faster than conventional methods and allow such steam to penetrate the outer layers of the feed to act as a lubricant through the forming process. The creation and addition of wet steam is the only viable method for adding moisture to the feed to act as a lubricant. Adding water via soaking to reduce the mechanical shear effects is both extremely hard to remove and can be detrimental to the feed quality. Product forming equipment can easily remove steam added moisture in the outer layers of the feed, but the equipment has difficulty removing moisture from deep within the feed particles if the feed is soaked in water to provide the lubricating effect. In addition, micro-organisms thrive in this excess moisture condition which can reduce the shelf life.

The animal feed industry typically uses product sizing equipment, such as hammer mills, for feed processing because they are efficient and fast. In addition, corn is usually the primary fill material or feed stock of most feed pellets. Most of the amino acids including lysine reside in the outer layers of corn. Blunt force trauma and shear forces can destroy the lysine and most amino acids. When part of a long chain protein is destroyed, that protein no longer has the same characteristics. Between blunt force trauma and excessive heat, substantial portions of the intrinsic amino acids and enzymes within the feedstock are destroyed during processing.

Accordingly, product forming techniques such as milling and grinding need to be less abusive during processing of feed. In addition, creating more large particles will destroy less of the intrinsic proteins found within the feed and allows the retention of more of the crucial lysine and other amino acids. In total, increased retention will improve the feed gain on pellets and reduce the amount of amino acids that is needed to be added. Furthermore, creating an enhanced particle size distribution profile can improve the physical characteristics in the feed pellet. An enhanced particle distribution with more moisture in the particles allows the pellet to bind together significantly better and reduces the creation of fines. Creating less fines reduces waste and significantly improves the pellet creation process

### BRIEF SUMMARY OF THE INVENTION

The present invention discloses compositions and methods in various embodiments for maximizing utilization of amino acids and enzymes in feed stock while reducing the operating costs associated with producing feed pellets.

In an embodiment, a method is disclosed for improving feed conversion through retention and utilization of amino acids and enzymes in feedstock and reducing operating costs by a new process using a steam generating device to generate steam, using steam with a maximum 90 pounds of steam pressure at a steam generating device exit, using steam with a maximum of 331 degrees Fahrenheit at an entrance of a conditioner container; and using the steam and the feedstock to create feed pellets.

In one embodiment, the steam generating device is a steam boiler, and a conditioner steam valve down-stream of the steam boiler is at least 75% open. In this embodiment, a conditioner load is at least 70% full in the conditioner container.

In a conditioner with paddles, the paddles are adjusted to increase the feed stock's contact with the steam. In a preferred embodiment, at least two paddles are reversed to negative between 5 to 9 degrees, at least two paddles are set forward between 5 to 9 degrees, and an initial and outlet paddle are set forward between 40 and 50 degrees. This paddle arrangement helps ensure the conditioner is at least 70% full.

In one embodiment, a grinding and milling process for the feedstock creates a distribution of particles, wherein a majority of the particles are larger coarse particles over 700 microns leaving the milling and grinding process. Larger particles are subject to less blunt force trauma and more of the feedstock's intrinsic amino acids and enzymes are retained.

In this embodiment, the distribution of particles comprises of 10% or less of small particles less than 400 microns, 50% or less of medium particles in the range of 400 microns to 700 microns, and a maximum of 65% of the larger coarse particles over 700 microns.

As disclosed, the milling and grinding process is often achieved in a hammer mill. In this embodiment, the hammer mill will use a target value of 800 rpms or less using a variable frequency drive. Further disclosed, the hammer mill operates with a damper opened that will increase air flow.

In an embodiment, product forming equipment is used that will create a temperature change between the feedstock entering the product forming equipment and exiting the product forming equipment. This temperature change will have a delta maximum temperature of 10 degrees Fahrenheit. In addition, the feedstock exiting the product forming equipment is at a maximum temperature of 190° Fahrenheit. The delta maximum temperature is achieved by a combination of throughput speeds, lubrication added to the feed stock from the steam resulting in a reduction of mechanical shear, and product forming pressures.

In another embodiment, a method for improving feed conversion through retention and utilization of amino acids and enzymes in feedstock is achieved by faster cooling of the feedstock within a cooler. Creating less fines allows for greater air flow in the cooler resulting in faster cooling of the feedstock. In addition, it is important that adequate air flow exists. Consequently, the fans are run at near max speed. Also, a cooler with a near full level bed depth helps ensure even air flow. Otherwise, volumes of air may flow where the beds have minimal pellets due to lack of air flow resistance.

In one embodiment, the feedstock is cooled in a horizontal cooler after exiting product forming equipment. The feedstock is a maximum of 5 degrees Fahrenheit over ambient temperature after a first pass in the horizontal cooler.

In another embodiment, the feedstock is cooled in a counterflow cooler after exiting product forming equipment. The feedstock is a maximum of 5 degrees Fahrenheit over ambient temperature at least two feet above the discharge of the counterflow cooler.

In some embodiments, the feedstock exiting either cooler is at an exit temperature equal to or less than ambient temperature. The static pressure within the coolers is greater than 3 millibars. The static pressure is achieved by a combination of a minimum of 90% of a maximum fan speed and a minimum of 90% of a full bed depth of the feed stock.

In yet another embodiment, an improved feed pellet is made from feedstock using this new process. A majority of all new process particles creating the improved feed pellet are larger coarse particles over 700 microns.

In this embodiment, the feedstock used to create the improved feed pellet was not exposed to steam temperatures over 331 degrees Fahrenheit during the new pellet creation process.

As disclosed, the feedstock entering the product forming equipment and exiting the product forming equipment has a new process delta maximum temperature of 10 degrees Fahrenheit.

Further disclosed, the feed stock is cooled within a cooler container with a new process static pressure greater than 3 millibars achieved by a combination of a minimum of 90% of a maximum fan speed and a minimum of 90% of a full bed depth of the feedstock.

In this embodiment, the improved feed pellet has at least an 10% increase in an amount of bio-absorbable retained lysine, methionine, and threonine compared to an old process feed pellet that was created by an old pellet creation process.

In this embodiment, the old pellet creation process comprises grinding the feedstock into old process particles that have less than a majority that are larger coarse particles over 700 microns. The old process exposes the feedstock to steam temperatures over 331 degrees Fahrenheit. In addition, all old process particles entering the product forming equipment and exiting the product forming equipment have an old process delta temperature over 10 degrees Fahrenheit and cooling the feedstock within the cooler with an old process static pressure less than 3 millibars.

### BRIEF DESCRIPTION OF THE DRAWINGS

Various embodiments are illustrated by way of examples in the figures of the accompanying drawings. Such embodiments are demonstrative and not intended to be exhaustive or exclusive embodiments of the present subject matter. The drawings are not necessarily to scale, emphasis instead being placed on illustrating the principals of the invention.

FIG. 1 is a diagram depicting the major equipment and flow of food source in a preferred embodiment.

FIG. 2 depicts a grinding mechanism in a preferred embodiment.

FIG. 3 depicts a conditioner with paddles in a preferred embodiment.

FIG. 4 depicts a pellet die with rollers in a preferred embodiment.

FIG. 5 depicts a horizontal cooler in a preferred embodiment.

FIG. 6 depicts a counter flow cooler in a preferred embodiment.

### DETAILED DESCRIPTION OF THE INVENTION

The description that follows includes compositions, systems, methods, and apparatuses that embody various elements of the present disclosure. However, it should be understood that the described disclosure may be practiced in a variety of forms in addition to those described herein. Accordingly, the referenced drawings show, by way of illustration, specific embodiments in which the invention may be practiced. It is to be understood that other embodiments may be utilized, and structural changes may be made without departing from the scope of the claims. It is further understood that the steps described with respect to the disclosed processes may be performed in differing order and are not limited to the steps presented herein. Accordingly, other methods of product sizing and product forming processes, elements, parts or mechanisms can be used and still be within the scope of the claimed invention.

In the preferred embodiments described herein, the process will create a significantly better feed product. The process will allow for increased retention of intrinsic amino acids and enzymes. This process will also create better feed quality with more stable products and less fines in the final product. By reducing the mechanical shear forces and the applied steam temperatures, the process decreases water usage, decreases wear on the mill components, decreases the cost of additional added nutrients, and decreases the overall energy costs associated with feed production. Creating a better feed product results in significantly better feed utilization, longer shelf storage life, and most importantly, better feed conversion.

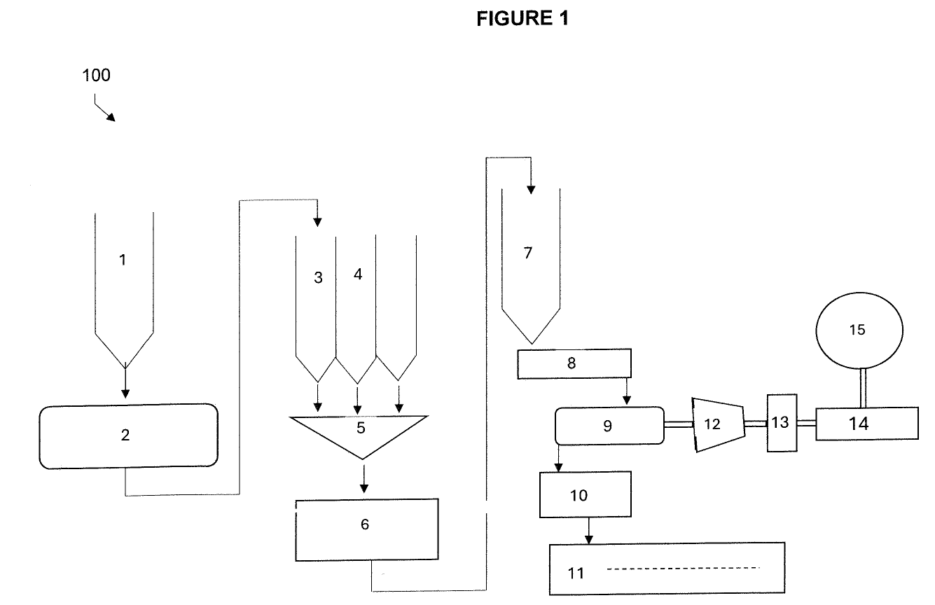

Referring to FIG. 1, illustrated is diagram 100 depicting the major equipment and flow of food source in the preferred embodiment.

In this preferred embodiment, a food source bin 1 stores any food source to be used in the pellet feed. Corn, prized for its high energy content from starch, is the most commonly utilized food source. Various grains and cereals along with other food stock can also be used in the formulation of feed pellets for livestock.

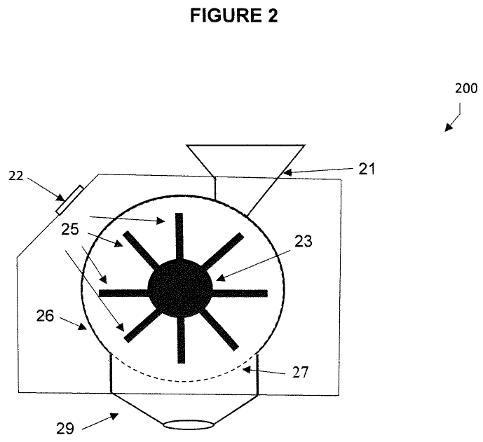

After the food source bin 1, the feed stock enters the product sizing, grinding and milling equipment 2. One example of the product sizing, grinding and milling is illustrated further in reference to FIG. 2. Product sizing, grinding and milling is crucial to achieving a high pellet quality. The product sizing process should be modified to create a broad distribution of particles. Larger particles are subjected to less shearing and therefore maintain significantly higher concentrations of useful amino acids. Smaller particles have reduced effectiveness of the intrinsic proteins because of the application of destructive shear forces. Nevertheless, smaller particles have the ability to fill in gaps between the larger particles to create a better physical pellet that produces less fines.

After the food source leaves product sizing, grinding and milling equipment 2, the feedstock is stored in a ground food source bin 3. Other bins 4 contain other ingredients to be added to the primary food source. Additional amino acids and enzymes are typically added to the feedstock.

After grinding, the feedstock and the other ingredients enters scaling equipment 5. Scaling equipment 5 is used to precisely measure the quantities required for mixing. This step ensures accurate formulation of feed pellets, maintaining nutritional balance and consistency throughout the production process.

After scaling, the feedstock ingredients are thoroughly mixed in a mixer 6 to achieve a uniform blend to ensure even distribution of nutrients across the batch. A double ribbon mixer has ribbons that travel in opposite directions to increase the mixing efficiency. This mixing process is needed for maintaining consistent nutritional quality in the feed pellets before they proceed to further processing steps.

After mixing, the feedstock enters a mash bin 7 where it awaits conditioning.

As the feed stock leaves the mash bin 7, it is fed into a conveyor 8 that transports it to a conditioner container 9.

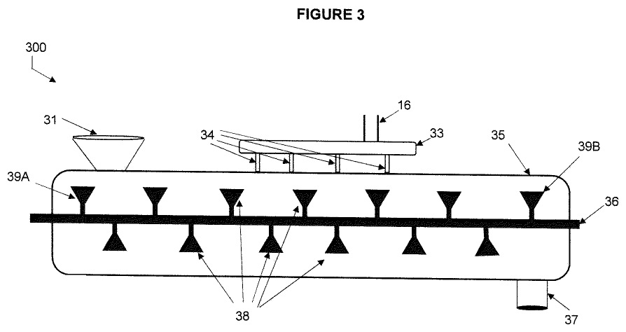

The steam conditioner 9 is fed by steam from a steam generating device 15. In the steam conditioner 9, the steam transfers energy and moisture to the feedstock. One example of a steam conditioner chamber 9 is illustrated further in reference to FIG. 3. The steam generating device 15 is connected to a steam header 14 which transfers the steam throughout the plant. The pressure of steam downstream of the header 14 is controlled by the steam regulator 13. The amount of steam flowing into the conditioner container 9 is controlled by the steam conditioner valve 12.

Using lower temperature steam will reduce the destruction of intrinsic enzymes and amino acids. Accordingly, the new top of range of steam exit pressure from the steam generating device 15 is 90 psi resulting in an exit temperature around 331° F. A lower 20 psi with an associated temperature of 258° F. is optimal if the steam has enough steam head to push the steam through the system piping 16. These lower steam pressures are achieved by opening the steam valve 12 to 75% to 100% open. After line losses, using steam with a temperature that results in an average temperature of 240° F. in the conditioner will result in a dramatic increase in the amount of useful proteins retained in the feed particles. This new process prefers average steam temperatures throughout the conditioner 9 below 268° F. and preferably in 240-250° F. range. The maximum injection into the conditioner 9 of 90 psi steam corresponding to 331° F. can be used with a full load in the conditioner 9. Ideally, the temperature and pressure are lowered as far as possible while still achieving a desired minimum temperature of 180° F. product process temperature without running out of boiler capacity.

Using a boiler to create 355 degree OF steam, then using a regulating valve 13 to reduce steam pressure is not an ideal method to create the lower steam pressures. Changing 110-pound steam to 30-pound steam using reducing valves 13 creates very high temperature superheated steam. Very high temperature steam has significantly more internal energy, turbulence, and shear, and requires a thermodynamic stage change to get the steam to the condensate point. Condensation is desired to increase moisture and lubrication in the mash. Of course, some pressure drop occurs when the steam travels through the plant steam lines 16. Consequently, the reducing valve 13 is adjusted to ensure only steam with no superheated temperature steam is present in the conditioner 9. Ideally, the regulating valve 13 is adjusted to allow the steam valve 12 to maintain a Max open setting. Because additional steps are required, it is desirable not to change steam phases. This new process adjusts a boiler 15 to create steam without superheated steam entering the conditioner 9.

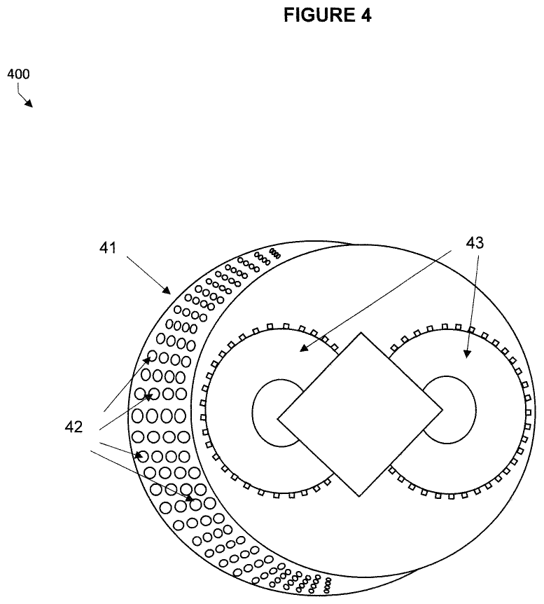

After conditioning, the mash enters a pellet mill 10. A pellet die with rollers 400 is further illustrated in reference to FIG. 4. Feed pellet forming involves compressing raw materials under high pressure through a die 41 to create compact feed pellets of uniform size and density, crucial for efficient feeding and nutrient intake in livestock. This process ensures consistency in pellet quality, optimizing nutrition delivery and digestibility for animals. The process ideally needs to reduce mechanical shear on the processing after steam conditioning. This step in the process introduces significant frictional heat when the feed particles enter the pellet mill 10. The pellet milling introduces extremely large pressures on the particles. In a typical pellet mill 10, 80% of feed is transformed into pellets while the remainder are loose fines. Increasing the moisture content in the mash increases the percentage of feed transformed into pellets and reduces the loose fines.

Condensate stage steam penetrates the outer shell of feed and acts as a lubricant allowing lower pressures on the rollers 43 and in the pellet mills 10. By using lower temperature near saturated steam and increasing the retention times, the moisture content of the outer layers of the feed is increased. This additional lubrication allows reducing the pressure in the pellet press 400 and significantly lowers the accumulated heat in the feed. Proteins can tolerate some higher heat but not for a long time duration. The target of the new process is 180° F. entering the pellet mill 10 and a temperature of only 182° F. at the die 400 exit. The throughput to the pellet mill 10 may be increased up to double from standard (100%) flow rate due to minimizing the mechanical shear force applied to the mash. Also, the die size 41 can be changed to minimize the applied shear force.

After the pellet mill 10, the feed is dropped into a cooling system 11. The cooler's 11 purpose is to remove added heat and moisture. Most feed processing plants do not worry about the static coolers 11. However, proteins can handle some heat for only short periods of time. The survival rate of the amino acids and enzymes are higher if the heat is removed quickly.

Referring to FIG. 2, depicted is a grinding mechanism 200 in a preferred embodiment. In the preferred embodiment, the process runs the feed through a product sizing device 2 such as a hammer mill 200 which has been adjusted to reduce the shear forces on the feed. The rotor shaft 23 is spun at a high speed inside the drum 26 while material is fed into a mill feed hopper 21. The material is impacted by the hammer bars 25 and is thereby shredded and expelled through screens 27 in the drum of a selected size. The material exits the device 200 via the exit chute 29.

The industry standard speed for the hammer mill 200 for producing animal feed pellets is around 1440 rpm. One method to reduce the shear forces imparted on the feed inputs is by operating at a reduced target of revolutions per minute. Thus, this new process uses less than 1440 rpms and has a target value around 750 rpm using a variable frequency drive (VFD). In addition, reducing blunt force problems and limiting mechanical shear can be achieved by changing the screen size 27, changing hammer 25 pattern, and increasing the air flow.

Most facilities differ slightly on milling and grinding strategies. Nevertheless, a current practice is generally to create consistent smaller particles with consistent uniform grinding. Most operators want a vast majority of approximately 70% of midsized particles (400-700 microns) which compress to make the best physical pellets. The remainder of the particles is roughly 29% large particles and 1% fines

However, larger pieces have more retained nutrients so changing the hammer 25 pattern to create a particle size distribution curve maximizing large particles is preferred. The screens in the hammer mill 200 can be changed by screen 27 size to ensure the particle distribution. Consequently, this new process targets the hammer mill 200 to produce larger feed particles in the blend: 5-10% on the low end (200-400 microns), 35-50% in the middle range (400-700 microns), and around 50-60% larger coarse pieces (700-1400 microns). These different particles size can assist with particle cohesion. Smaller particles fill the gaps created by the bigger particles. This distribution curve creates a better pellet and with increased amino acid retention because they have been subjected to reduced blunt force trauma.

In addition, increased air flow resulting in less time within the product sizing device can also achieve larger particles. Accordingly, create a lot of air flow in the product sizing device to reduce the grinding as much as possible. Opening a damper 22 in the product sizing device mill actually does not create dust but allows for the creation of a positive air flow to quickly suck the feed through.

Accordingly, in the preferred embodiment, the hammer 25 spacing and rotation speed are adjusted to hit the feed fewer times. This new process changes the gaps in the hammer 25, adjusts the screen 27 size, reduces the rotational speed, and increases air flow. The net result is a more stable pellet that has been subjected to less blunt force trauma.

Referring to FIG. 3, depicted a food stock conditioner with paddles 300 in a preferred embodiment. A mash bin 7 feeds the ground corn mixture into a conditioning container 35 via a conditioner feed hopper 31. After conditioning, the feed exits via a conditioner feed chute 37. The conditioner container 300 is fed by steam from steam generating device 15. Plant system piping 16 transfers the steam from the steam generator 15 to a conditioner steam header 33 and conditioner steam pipes 34 allow the steam to enter into the conditioner container 300. In the preferred embodiment, a boiler 15 has been adjusted to operate at significantly lower temperatures in order to achieve optimum moisture retention and maximum survival of amino acids and enzymes in the final product. Preferably, the steam is subjected to a large amount of mash surface area with an increased retention time. This process allows the moisture within the lower temperature steam to transfer heat more efficiently than very high temperature steam due to the increased water content and will also reduce the damage to the amino acids and enzymes. Using wet steam also increases the moisture content within the outer layers of the feed particles which helps in the lubrication of the pellets further along in the process and thereby allowing reduction of mechanical shear and thereby lowering heat transfer to the pellets. For every one percent of moisture added to the product in the conditioner results in a reduction of 2 degree F. in dye friction and at least an 8% reduction in mechanical shear.

When making pellets, higher steam temperatures create more heat and less moisture in the steam. Superheated steam contains less available moisture and therefore tries to absorb moisture from its local environment. Consequently, very hot steam robs moisture from the corn kernel and the corn does not form pellets well. The feed particles need moisture to form an adhesive pellet and to act as a protective lubricant through the forming process. Corn has around 15% latent internal moisture. Any superheated steam will pull the moisture from the inner portions of the corn and adds it to the steam load. This removal of moisture dries out the inside of the product. Dry mash tends to create loose fines and increases the total load of fines in the final product. Birds prefer the pellets and ignore loose fines because the beaks have difficulty grabbing the loose fines. Accordingly, high heat steam increases the fines. Lower heat along with longer retention time helps pellets stay together by increasing the moisture content of the outer layers of the mash while also maintaining the existing internal latent moisture.

In order to improve moisture and preserve the amino acids and enzymes intrinsic in the feed, 29 to 60 pounds of steam pressure and 272 to 307 degrees OF at the boiler exit is preferred. With some pressure drop in the system, the average temperature in the conditioner 9 should be under 268 degrees F. Although the facility needs enough steam pressure to run the system, the feed itself reduces the steam temperature within the conditioner 9 significantly because introducing the feed at ambient temperature will reduce the temperature of the steam. Evaporative and or condensate stage saturated steam temperatures actually transfer the heat faster because it does not require a thermodynamic phase change from superheated steam.

At these lower temperatures, the retention time in the conditioner needs to be increased to ensure proper heating to kill the undesirable microbes. The pressure required to achieve this temperature at the output of the boiler 15 needs to be adjusted for the downstream piping 16 such that the outlet pressure of the boiler 15 is specific to each processing plant. Using much lower steam pressure (temperature) and increased retention time in the conditioner increases the lubrication of the feed and greatly reduces the destruction of enzymes and amino acids. Consequently, the steam should hit the feed with a maximized full load of moisture such that the steam cools quickly. The desired goal is to use lower steam pressures and lower feed roll pressures during the product forming process to maximize the intrinsic amounts of useful proteins in the feed.

The industry standard conditioner load is about 30% full in order to minimize the time in the conditioner for maximum throughput. The new process increases the conditioner load to greater than 70% full. Loading is adjusted until the motor reaches the Max amps. The conditioner 300 should be as full as possible to achieve maximum steam contact with the feed to minimize steam escaping without making contact with the feed. Obviously, the feed stock particles are significantly cooler than steam. Thus, steam condenses on the particles surface forming a thin film of water. This water is absorbed into the particle adding lubrication to the particles. However, the mash must reach a minimum temperature of 180° F. to achieve the industry accepted Salmonella and harmful microbe destruction temperature.

Irrespective of paddle settings, the goal is to increase the retention and fill capacity of the conditioner. An exemplary method to achieve an increased conditioner fill loading is to adjust the paddles as follows. Paddles 38, 39A, 39B within the conditioner can be adjusted to assist with the steam contact maximization. Overall flatten the paddles out. Reverse some paddles 38 to negative 7 degrees, some paddles 38 are set to neutral (flat), and set some paddles 38 set to forward 7 degrees. The initial inlet 39A and outlet paddles 39B are set to forward 45 degrees. The paddles 38, 39A, 39B are rotated by a shaft 36. This process increases the heat transfer efficiency and a better distribution of the steam.

Referring to FIG. 4, depicted is a pellet die with rollers 400 in a preferred embodiment. The process ideally needs to reduce mechanical shear on the processing after steam conditioning. The next steps in the process introduce significant frictional heat when the feed particles enter the pellet mill 10. The pellet milling introduces extremely large pressures on the particles. In a typical pellet mill 10, 80% of feed is transformed into pellets while the remainder are loose fines. Increasing the moisture content in the mash increases the percentage of feed transformed into pellets and reduces the loose fines.

The industry typically likes increasing the thickness of the product forming equipment such as a pellet mill die 41. In the middle of the product forming pellet mill die 41 are 2 rollers 43; the die 41 spins and the rollers 43 are stationery. The feed gets shot in and the feed gets squeezed in between the rollers 43 and the die 41 creating an extreme amount of shear. The die holes 42 in the pellet mill die 41 compress the feed into pellets efficiently, ensuring consistent pellet formation. Properly sized die holes 42 also help regulate the flow of material, optimizing the pelletizing process for better quality output. Making the die 41 thicker increases the compression ratio. Increasing the compression creates a better physical pellet that looks good and reduces crumbs. However, the feed conversion is poor because the thicker die increases mechanical shear and destroys amino acids. Ideally, increasing the lubrication reduces the shear stress that allows for an increased thicker die size to reduce destruction of the proteins while creating a better pellet.

Condensate stage steam penetrates just the outer shell of feed and acts as a lubricant allowing lower pressures on the rollers and in the pellet mills. By using lower temperature steam and increasing the retention times, the moisture content of the outer layers of the feed is increased. Reducing the pressure in the pellet press reduces the accumulated heat in the feed. Proteins can tolerate some higher heat but not for a long time duration. The target of the new process is 180° F. entering the pellet mill and a temperature of only 182° F. at the die exit. The throughput to the pellet mill may be increased up to double from standard (100%) flow rate due to minimizing the mechanical shear force applied to the mash. Also, the die size can be changed to minimize the applied shear force.

The target temperature of feed into the pellet mill is a minimum of 180° F. Preferably, the exit temperature is desired to be 180° F. or less (0 degree delta) so no net energy is imparted by shear forces. Die thickness, the rollers, characteristics of holes all can be adjusted to achieve this net delta temperature.

The combination of increased throughput speeds and reduced pressures within the product forming equipment can dramatically reduce the delta temperature between the inlet and exit of the die and roll system. Consequently, this new process results in decreased die friction heat, increased throughput, decreased wear on the die and rollers, and increased retention of proteins. These results are mainly achieved by the increased lubrication of the moisture retained in the outer layers of the feed particles from the conditioning process.

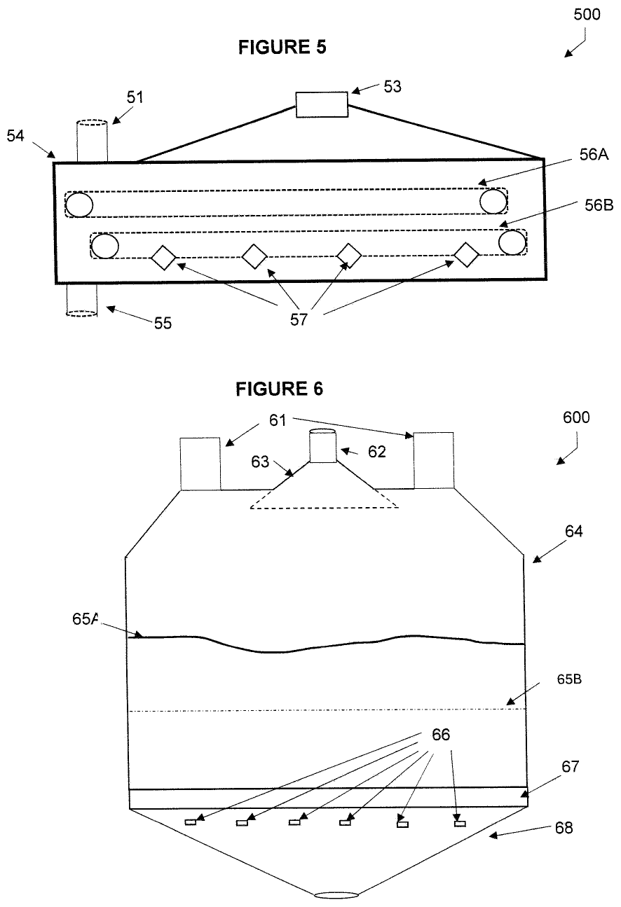

Referring to FIG. 5 depicts a horizontal cooler 500 in a preferred embodiment, while FIG. 6 depicts a counter flow cooler 600 in a preferred embodiment. After the pellet mill 10, the feed is dropped into a cooling system 11. The cooler's purpose is to remove added heat and moisture. Most feed processing plants do not worry about the coolers 11. However, proteins can handle some heat for only short periods of time. The survival rate of the amino acids and enzymes are higher if the heat is removed quickly. The latent heat in the particles can still destroy proteins. Adjust the coolers 11 for max delta of 5° F. over ambient when the feed pellets exit the whole process. Deltas as close to 0 degrees or less from ambient air temperature is the objective of this process. Moisture can flash off by evaporative cooling and the feed can exit the cooler at a lower temperature than ambient. The goal is to maximize enzyme and amino acid survival with lysine being the main target. Therefore, it is important adequate air flow exists. Ensure the fans are at max speed.

Preferably static pressure in a feed cooler is increased to approximately 5 millibars. This static pressure increase is achieved by increasing the rotational speed of the fans thereby increasing airflow and increasing the bed depth within the cooler. Together, these adjustments allow for better heat dissipation and ensure that the feed remains at an optimal temperature.

Horizontal feed coolers 500 play a vital role in the pellet production process by efficiently cooling pellets as they move through the cooler horizontally. Many horizontal coolers 500 have more than one row of beds 56A, 56B. In the illustrated horizontal cooler 500, the horizontal cooler 500 has two rows of beds 56A, 56B within the cooler housing 54.

In the horizontal cooling system 500, air comes in from the air inlets 57 near the bottom and has a fan 53 at the top. This step removes moisture and heat to help preserve the pellets. The hot air flows upward in the horizontal cooler container 54, removes moisture, and flows out of the fan assembly 53.

The key components of a horizontal feed cooler 500 typically include a cooler inlet 51 where hot pellets enter, a rotating distribution mechanism or beds 56A, 56B that spreads the pellets evenly across the cooler's width, and a cooler discharge outlet 55 for cooled pellets. Ensure the cooler has a full level bed depth to ensure even air flow. Otherwise, increased volumes of air may flow where the beds 56A, 56B have minimal pellets due to lack of air flow resistance. Because of the reduction in fines that block air flow and increased static pressure in the cooler 500, the feedstock can achieve a maximum of 5 degrees Fahrenheit over ambient temperature after a first pass in the horizontal cooler 500. Horizontal feed coolers are integral in maintaining pellet quality by reducing temperature swiftly and uniformly.

Counter flow feed coolers 600 are essential components in pellet production lines, designed to reduce the temperature of pellets efficiently after they exit the pellet mill 10. The main parts of a counter flow feed cooler 600 typically include a cooler inlet 62 for hot pellets, a cooling chamber 64 where pellets and cool air move in opposite directions to facilitate heat exchange, and a cooler outlet 68 for cooled pellets. Some coolers also incorporate features such as a feed distribution system 63 to minimize pellet breakage and ensure uniform spreading on the cooler rack 67 to a desired height 65A where the cooling system 62 can maintain effectiveness.

Efficient cooling is crucial as it stabilizes the pellets. Air inlet holes 66 in the bottom of the counter flow cooler 600 provides the cool air necessary for fan cooling system 62. Because of the reduction in fines that block air flow and increased static pressure in the cooler 600, a fan cooling system 61 can swiftly cool the feed stock. This counterflow cooler 600 achieve a maximum of 5 degrees Fahrenheit over ambient temperature at line 65B least two feet above the discharge 67 of the counterflow cooler.

In conclusion, feed mills in order to be efficient need to utilize steam better. Boilers need to adjust steam pressure to be able to use lubrication from the moisture of the steam in addition to the oils naturally in the feed. Minimizing heat and mechanical shear greatly increases the retained amino acids and enzymes within the feed. Maximizing proteins in feed, allows animals to convert the feed better and eat less feed to become bigger faster. In addition, this process creates better quality feed pellets that have less fine particles and crumbs increasing feed utilization and decreasing overall costs due to wasted feed.

This enhanced process decreases overall boiler expense and can increase boiler life, reduces boiler chemical expenses, utilizes less water, dramatically reduces fuel usage in boiler, and the overall power consumption is greatly reduced. A significant cost savings arises from the reduction of added lysine or other enzymes and proteins. Thus, the operating cost of the feed mill is significantly reduced.

1. A method for improving feed conversion through retention and utilization of organic acids and enzymes in feedstock and reducing operating costs, comprising:
a. using a steam generating device to generate steam;
b. using steam with a maximum 90 pounds of steam pressure at a steam generating device exit;
c. using a maximum of 331 degrees Fahrenheit steam at an entrance of a conditioner container; and
d. using the steam and the feedstock to create feed pellets.

2. The method of claim 1, wherein the steam generating device is a steam boiler, and wherein a conditioner steam valve down-stream of the steam boiler is at least 75% open.

3. The method of claim 1, wherein a conditioner load in the conditioner container is at least 70% full.

4. The method of claim 3, wherein paddles within the conditioner container are adjusted to increase steam contact, wherein at least two paddles are reversed to negative between 5 to 9 degrees, at least two paddles are set forward between 5 to 9 degrees, and an initial and outlet paddle are set forward between 40 and 50 degrees.

5. The method of claim 1, further comprising a grinding and milling process for the feedstock that creates a distribution of particles, wherein a majority of the particles are larger coarse particles over 700 microns leaving the milling and grinding process.

6. The method of claim 5, wherein the distribution of particles comprises of 10% or less of small particles less than 400 microns, 50% or less of medium particles in the range of 400 microns to 700 microns, and a maximum of 65% of the larger coarse particles over 700 microns.

7. The method of claim 5, wherein the milling and grinding process is achieved in a hammer mill, wherein the hammer mill uses a target value of 800 rpms or less using a variable frequency drive.

8. The method of claim 7, wherein the hammer mill operates with a damper opened that increases air flow.

9. The method of claim 1, further comprising product forming equipment wherein a temperature change between the feedstock entering the product forming equipment and exiting the product forming equipment has a delta maximum temperature of 10 degrees Fahrenheit.

10. The method of claim 9, wherein the feedstock exiting the product forming equipment is at a maximum temperature of 190° Fahrenheit.

11. The method of claim 9, wherein the delta maximum temperature is achieved by a combination of throughput speeds, lubrication added to the feed stock from the steam resulting in a reduction of mechanical shear, and product forming pressures.

12. A method for improving feed conversion through retention and utilization of organic acids and enzymes in feedstock, comprising either:
(i) cooling the feedstock in a horizontal cooler after exiting product forming equipment, wherein the feedstock after a first pass in the horizontal cooler is a maximum of 5 degrees Fahrenheit over ambient temperature, or
(ii) cooling the feedstock in a counterflow cooler after exiting product forming equipment, wherein the feedstock is a maximum of 5 degrees Fahrenheit over ambient temperature at least two feet above the discharge of the counterflow cooler.

13. The method of claim 12 wherein the feedstock exiting either cooler is at an exit temperature equal to or less than ambient temperature.

14. The method of claim 12, wherein a static pressure within either cooler is greater than 3 millibars.

15. The method claim 14, wherein the static pressure is achieved by a combination of a minimum of 90% of a maximum fan speed and a minimum of 90% of a full bed depth of the feed stock.

16. An improved feed pellet made from feedstock wherein the improved feed pellet is comprised of a majority of all new process particles creating the improved feed pellet are larger coarse particles over 700 microns.

17. The improved feed pellet of claim 16, wherein a distribution of the all new process particles comprises of 10% or less of small particles less than 400 microns, 50% or less of medium particles in the range of 400 microns to 700 microns, and a maximum of 65% of the larger particles over 700 microns.

18. The improved feed pellet of claim 16 wherein the feedstock used to create the improved feed pellet was not exposed to steam temperatures over 331 degrees Fahrenheit during a new pellet creation process.

19. The improved feed pellet of claim 18 wherein the feedstock entering the product forming equipment and exiting the product forming equipment has a new process delta maximum temperature of 10 degrees Fahrenheit, and wherein the feed stock is cooled within a cooler container with a new process static pressure greater than 3 millibars achieved by a combination of a minimum of 90% of a maximum fan speed and a minimum of 90% of a full bed depth of the feedstock.

20. The improved feed pellet of claim 19 wherein the improved feed pellet has at least an 10% increase in an amount of bio-absorbable retained lysine, methionine, and threonine compared to an old process feed pellet that was created by an old pellet creation process wherein in the old pellet creation process comprises:
a. grinding the feedstock into old process particles that has less than a majority that are larger coarse particles over 700 microns,
b exposing the feedstock to steam temperatures over 331 degrees Fahrenheit during the old pellet creation process,
c. all old process particles entering the product forming equipment and exiting the product forming equipment has an old process delta temperature over 10 degrees Fahrenheit, and
d. cooling the feedstock within the cooler container with an old process static pressure less than 3 millibars.
